(19) United States
(12) Patent Application Publication
(10) Pub. No.: US 2026/0366890 A1
(43) Pub. Date: Nov. 19, 2026

(54) STEERING WHEEL GRIP DETECTION SENSOR, METHOD OF MANUFACTURING THE SAME, AND GRIP DETECTING STEERING WHEEL

(71) Applicant: KOMOS CO., LTD., Hwaseong-si Gyeonggi-do (KR)

(72) Inventors: In Chul YOO, Hwaseong-si Gyeonggi-do (KR); Hyeoung Seok SONG, Suwon-si Gyeonggi-do (KR); Seok Hwan JI, Suwon-si Gyeonggi-do (KR)

(73) Assignee: KOMOS CO., LTD., Hwaseong-si Gyeonggi-do (KR)

(21) Appl. No.: 19/402,056

(22) Filed: Nov. 26, 2025

(30) Foreign Application Priority Data
May 15, 2025 (KR) 10-2025-0062991

(51) Int. Cl. G01D 5/24; B62D 1/06

(52) U.S. Cl. CPC G01D 5/24; B62D 1/06

(57) ABSTRACT

Provided are a steering wheel grip detection sensor, a method of manufacturing the same, and a grip detection steering wheel. A capacitive steering wheel grip sensor includes a stretchable fabric type sensor layer, a stretchable fabric type shield layer, and a dielectric layer disposed between the sensor layer and the shield layer, and the sensor layer includes a sensing unit woven with a conductive yarn and a guard unit woven with a non-conductive yarn to detect a driver's grip.

### CROSS-REFERENCE TO RELATED APPLICATIONS

This application claims priority to Korean Patent Application No. 10-2025-0062991 filed on May 15, 2025, the entire contents of which are herein incorporated by reference.

### BACKGROUND

### 1. Field

The disclosure relates to a steering wheel grip detection sensor, a method of manufacturing the same, and a grip detection steering wheel. More particularly, the disclosure relates to a grip detection sensor that detects whether a driver grips a steering wheel in a capacitive method by placing a stretchable fabric type sensor layer and a shield layer, and a dielectric layer therebetween, a method of manufacturing the grip detection sensor, and a grip detection steering wheel.

### 2. Description of the Related Art

Autonomous vehicles perceive their surrounding environments by themselves without driver intervention and control vehicles by determining driving situations. Recently, these autonomous cars have attracted attention as means of transportation capable of reducing traffic accidents, increasing traffic efficiency, reducing fuel, and increasing driver convenience by replacing driving.

However, in some cases, driver intervention may be necessary depending on driving conditions. In such situations, vehicles in an autonomous driving mode need to immediately transfer control of the vehicles to drivers.

Therefore, autonomous cars need to check whether drivers are gripping steering wheels during autonomous driving, and need to warn the drivers for safety when the drivers do not grip the steering wheels when it is necessary to transfer control to the drivers.

In the related art, cameras or infrared sensors are used to detect whether drivers are gripping the steering wheels, but there are many cases of misrecognition depending on surrounding environments.

In addition, film sensors or metal wiring-based sensors are used in the related art, but the film sensors or the metal wiring-based sensors are not easy to attach to curved shapes of the steering wheels, and there is a high risk of disconnection or damage that occurs when the sensors themselves bend or stretch. In the case of fixed sensors in the form of a metal plate electrode, the sensors have low physical elasticity, which make drivers feel discomfort when the drivers grip steering wheels, causing inconvenience to the drivers or problems such as cover wear when the steering wheels are used for a long time.

### SUMMARY

Provided are a steering wheel grip detection sensor that may be naturally mounted on a curved shape of a steering wheel to accurately detect a driver's grip state, a method of manufacturing the steering wheel grip detection sensor, and a grip detection steering wheel.

The solutions of the disclosure are not limited to the above-mentioned contents, and other technical problems not mentioned will be clearly understood by one of ordinary skill in the art from the following description.

According to an embodiment of the disclosure, a capacitive steering wheel grip sensor includes a stretchable fabric type sensor layer, a stretchable fabric type shield layer, and a dielectric layer disposed between the sensor layer and the shield layer, and the sensor layer includes a sensing unit woven with a conductive yarn and a guard unit woven with a non-conductive yarn to detect a driver's grip.

The sensor layer may be divided into a front detection region to detect a front side of a steering wheel and a rear detection region to detect a rear side of the steering wheel, and woven with a non-conductive yarn between the front detection region and the rear detection region.

The shield layer may have a shape corresponding to the sensor layer and include a shield unit woven with a conductive yarn.

The conductive yarn may be woven in a winding pattern in the sensing unit.

The sensing unit and the guard unit may have the same surface height.

According to another embodiment of the disclosure, a method of manufacturing a steering wheel grip detection sensor includes weaving a fabric including a sensor layer and a shield layer into a preset shape, by using a weaving apparatus, manufacturing a sensor pad by placing a dielectric layer between the sensor layer and the shield layer and combining the sensor layer with the shield layer, by using a combining apparatus, and cutting the combined sensor pad to fit a shape of a steering wheel.

With respect to a center line in a longitudinal direction, the sensor layer may be woven on one side of the fabric, and the shield layer may be woven on the other side so as to be symmetrical to the sensor layer, and the manufacturing of the sensor pad may include folding the fabric with respect to the center line such that the sensor layer and the shield layer overlap each other at a corresponding position.

The method may further include combining a heating pad manufactured to fit the shape of the steering wheel with the cut sensor pad, and the combining of the heating pad may include sucking the sensor pad on a first jig, sucking the heating pad on a second jig, and compressing the sensor pad and the heating pad by pressing the first jig and the second jig to each other.

The method may further include inspecting whether there is a defect by measuring a capacitance between the sensor layer and the shield layer.

According to another aspect of the disclosure, a grip detection steering wheel includes a rim of a steering wheel, and a grip detection sensor surrounding the rim and detecting whether a driver grips the rim, the grip detection sensor includes a stretchable fabric type sensor layer, a stretchable fabric type shield layer, and a dielectric layer disposed between the sensor layer and the shield layer, and the sensor layer includes a sensing unit woven with a conductive yarn and a guard unit woven with a non-conductive yarn to detect a driver's grip.

The sensor layer may be divided into a front detection region to detect a front side of the steering wheel and a rear detection region to detect a rear side of the steering wheel, and woven with a non-conductive yarn between the front detection region and the rear detection region.

### BRIEF DESCRIPTION OF THE DRAWINGS

FIG. 1 is a diagram illustrating a steering wheel grip detection sensor according to an embodiment of the disclosure;

FIG. 2 is a diagram illustrating a structure of a steering wheel grip detection sensor according to an embodiment of the disclosure;

FIG. 3 is a photograph of a sensor layer according to an embodiment of the disclosure;

FIG. 4 is a diagram illustrating a guard unit woven only with a non-conductive yarn according to an embodiment of the disclosure;

FIG. 5 is a diagram illustrating a sensor unit woven by including a conductive yarn according to an embodiment of the disclosure;

FIGS. 6 and 7 are diagrams illustrating conductive yarn weaving patterns of a sensor unit according to an embodiment of the disclosure;

FIG. 8 is a conceptual diagram illustrating a method of manufacturing a steering wheel grip detection sensor according to an embodiment of the disclosure;

FIG. 9 is a flowchart of a method of manufacturing a steering wheel grip detection sensor according to an embodiment of the disclosure;

FIG. 10 is a diagram illustrating a fabric according to an embodiment of the disclosure;

FIG. 11 is a conceptual diagram illustrating a process of combining a sensor pad according to an embodiment of the disclosure;

FIG. 12 is a diagram illustrating a sensor pad according to an embodiment of the disclosure;

FIG. 13 is a flowchart of a method of manufacturing a steering wheel grip detection sensor according to an embodiment of the disclosure;

FIG. 14 is a diagram illustrating combining a sensor pad with a heating pad by using jigs; and

FIG. 15 is a flowchart of a method of manufacturing a steering wheel grip detection sensor according to an embodiment of the disclosure.

### DETAILED DESCRIPTION

The disclosure will now be described more fully with reference to the accompanying drawings, in which embodiments of the disclosure are shown. These embodiments are provided so that the disclosure will be thorough and complete, and will fully convey the concept of the disclosure to those of skill in the art. The disclosure may, however, be embodied in many different forms and should not be construed as being limited to the embodiments set forth herein. For clarity, portions that are not relevant to the description of the present disclosure are omitted.

The terms used in the present specification are merely used to describe particular embodiments of the disclosure, and are not intended to limit the disclosure. An expression used in the singular encompasses the expression of the plural, unless it has a clearly different meaning in the context.

In the present specification, it is to be understood that the terms such as “including”, “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In addition, the components shown in the embodiments of the disclosure are shown independently to represent different characteristic functions, and do not mean that each component includes separate hardware or one software unit. That is, each component is described by listing each component for convenience of description, and at least two of the components may be combined to form one component, or one component may be divided into a plurality of components to perform a function. The integrated and separated embodiments of each of these components are also included within the scope of the disclosure without departing from the spirit of the disclosure.

In addition, embodiments below are provided so that the present disclosure will be thorough and complete, and will fully convey the concept of the disclosure to those skilled in the art. In the drawings, sizes and thicknesses of components may be exaggerated for clarity.

Hereinafter, the disclosure will be described in detail with reference to the attached drawings.

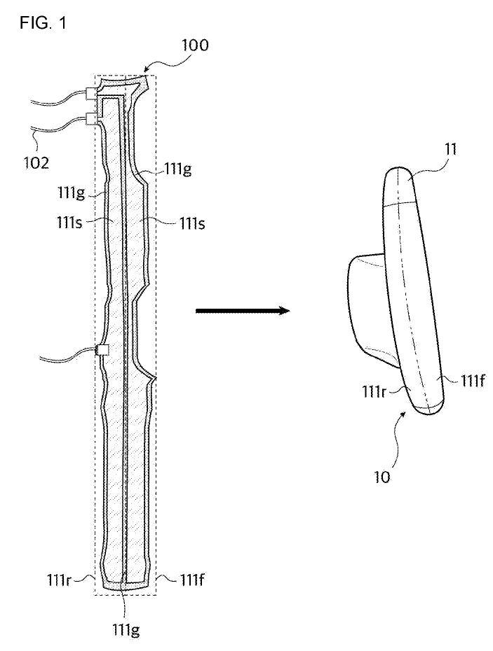

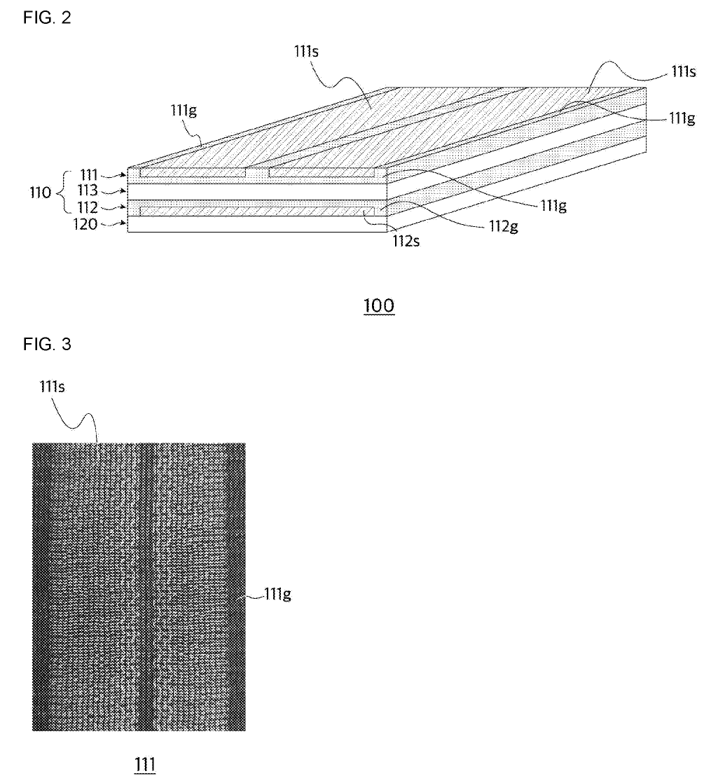

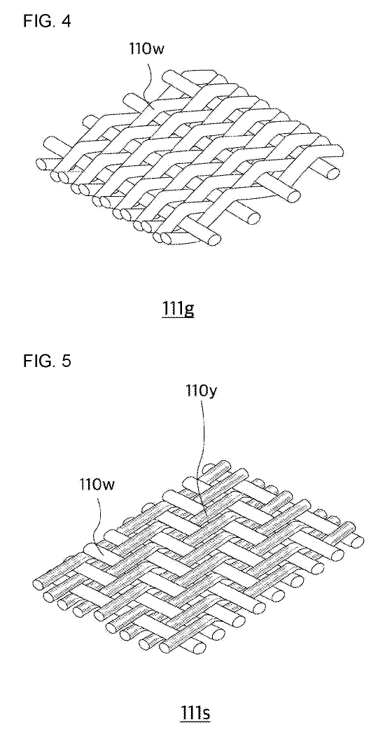

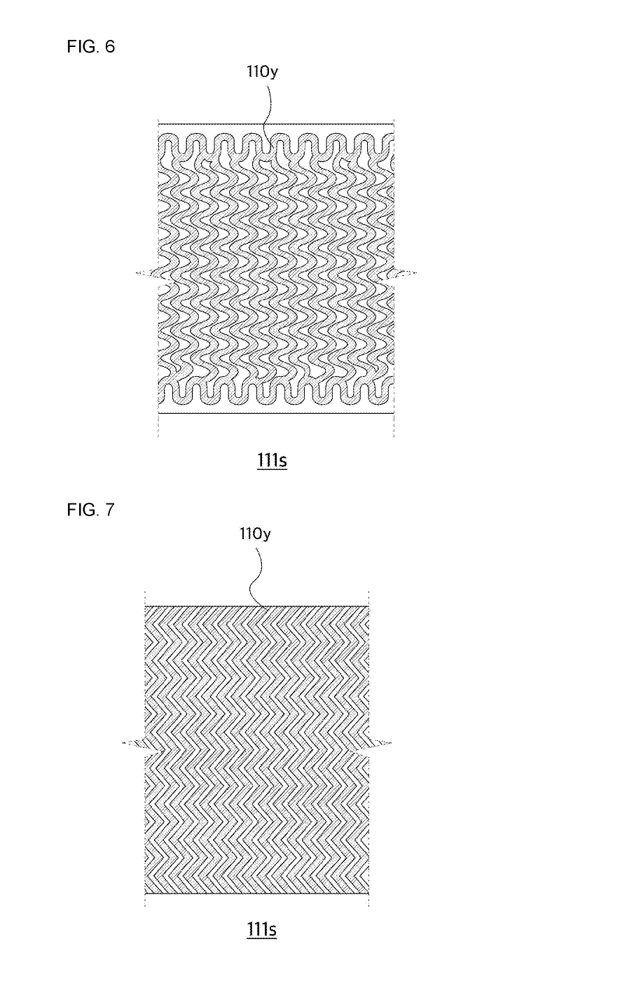

FIG. 1 is a diagram illustrating a steering wheel grip detection sensor according to an embodiment of the disclosure. FIG. 2 is a diagram illustrating a structure of the steering wheel grip detection sensor according to an embodiment of the disclosure. FIG. 3 is a photograph of a sensor layer according to an embodiment of the disclosure. FIG. 4 is a diagram illustrating a guard unit woven only with a non-conductive yarn according to an embodiment of the disclosure. FIG. 5 is a diagram illustrating a sensor unit woven by including a conductive yarn according to an embodiment of the disclosure. FIGS. 6 and 7 are diagrams illustrating conductive yarn weaving patterns of the sensor unit according to an embodiment of the disclosure.

Referring to FIGS. 1-7, a steering wheel grip detection sensor 100 according to an embodiment of the disclosure is for detecting whether a driver grips a rim 11 of a steering wheel 10 in a capacitive method, and may be mounted on the rim 11 to surround the rim 11.

The steering wheel grip detection sensor 100 according to an embodiment of the disclosure may include a stretchable fabric type sensor layer 111 and a shield layer 112, and a dielectric layer 113 disposed therebetween. The sensor layer 111 and the shield layer 112 may respectively include a sensor unit 111s and a shield unit 112s that are woven with conductive yarns for serving as electrodes. In addition, the sensor layer 111 and the shield layer 112 may respectively include guard units 111g and 112g that are woven with non-conductive yarns.

The steering wheel grip detection sensor 100 of the disclosure may detect a grip state by measuring a change in capacitance between the sensor unit 111s of the sensor layer 111 and the shield unit 112s of the shield layer 112 that occurs when the driver grips the rim 11.

That is, the sensor unit 111s and the shield unit 112s operate as both electrodes of a capacitor, to determine whether the driver grips the rim 11 through the capacitance formed between the two electrodes. One sensor unit 111s and shield unit 112s constitute one capacitor, and the capacitance varies when a driver's hand contacts the sensor unit 111s, and thus, the steering wheel grip detection sensor 100 may identify the grip state.

Specifically, when the driver grips the rim 11 on which the steering wheel grip detection sensor 100 is mounted, a driver's palm is electrically linked to the sensor unit 111s serving as an electrode, so that the steering wheel grip detection sensor 100 may operate as if the sensor unit 111s has a larger area. When an effect of increasing the area of the sensor unit 111s occurs, the capacitance measured by being formed between the sensor unit 111s and the shield unit 112s increases, and when an increasing value is greater than or equal to a preset threshold, the steering wheel grip detection sensor 100 may determine that the hand is gripping the rim 11.

In an embodiment, the sensor layer 111 may be woven with a non-conductive yarn 110w but may include and be woven with a conductive yarn 110y in some regions. As shown in FIG. 4, a region woven only with the non-conductive yarn 110w may be understood as the guard unit 111g, and as shown in FIG. 5, a region including and woven with the conductive yarn 110y may be understood as the sensor unit 111s.

When the sensor layer 111 is woven, the sensor unit 111s and the guard unit 111g may be woven to have the same surface height as shown in FIG. 2. The sensor unit 111s and the guard unit 111g have the same surface height, and thus, discomfort may be reduced or durability may be improved when a cover or a finish material of the rim 11 is mounted on the steering wheel grip detection sensor 100.

When the steering wheel grip detection sensor 100 is mounted on the rim 11 of the steering wheel 10, the sensor layer 111 may be divided into a front detection region 111f mounted in a direction toward the driver and a rear detection region 111r mounted in the opposite direction. The sensor unit 111s may be formed in each of the front detection region 111f and the rear detection region 111r. The guard unit 111g woven only with a non-conductive yarn is formed in each of the front detection region 111f and the rear detection region 111r such that the front detection region 111f and the rear detection region 111r may be divided.

In an embodiment, the sensor unit 111s may be woven such that the conductive yarn 110y woven over the non-conductive yarn 110w forms a predetermined pattern. As shown in FIGS. 5 and 6, the sensor unit 111s may be woven such that the conductive yarn 110y form a winding pattern. Specifically, the sensor unit 111s may extend in one direction and have a winding pattern. The winding pattern of the conductive yarn 110y may reduce the risk of disconnection when the steering wheel grip detection sensor 100 stretches or is attached to a curved surface, and may maintain a more uniform contact area. For example, the winding pattern may be a wavy pattern shown in FIG. 6 or a straight zigzag pattern shown in FIG. 7, but is not limited thereto, and various embodiments may be applied as long as the sensor unit 111s woven with the conductive yarn 110y may serve as an electrode. Meanwhile, a conductive yarn weaving form of the shield unit 112s of the shield layer 112 may be the same as a conductive yarn weaving form of the sensor unit 111s.

The shield layer 112 according to an embodiment of the disclosure may have the same stretchable fabric type as the sensor layer 111, and unlike the sensor unit 111s of the sensor layer 111 divided into the front detection region 111f and the rear detection region 111r and disposed in several regions, the shield unit 112s of the shield layer 112 may be formed as a single region to correspond to the entire sensor unit 111s. In the shield layer 112, the shield unit 112sincluding and woven with a conductive yarn may be woven as a single region, and the guard unit 112g may be formed around the shield unit 112s.

The shield unit 112s of the shield layer 112 may be implemented by including and being woven with a conductive yarn. Like the conductive yarn woven in the sensor unit 111s, the conductive yarn of the shield unit 112s may be woven in a wavy or zigzag pattern to increase durability against stretching and bending. Such a conductive yarn weaving pattern allows the shield layer 112 to efficiently stretch when attached to or mounted on the curved surface of the rim 11 of the steering wheel 10, and reduces the risk of disconnection or damage to the shield unit 112s.

The guard unit 112g of the shield layer 112 may be woven with a non-conductive yarn to partition or reinforce the periphery of the shield unit 112s. Like the sensor layer 111, the shield unit 112s and the guard unit 112g in the shield layer 112 may be woven to have the same surface height. Accordingly, even after the shield layer 112 is combined with the sensor layer 111, a thickness between the layers remains uniform, and thus, discomfort may be reduced and overall durability may be improved when a cover or a finish material is covered over the rim 11 of the steering wheel 10.

The dielectric layer 113 according to an embodiment of the disclosure may be disposed between the sensor layer 111 and the shield layer 112 to form a gap such that the two layers are not in direct electrical contact. The dielectric layer 113 may be formed of a material having insulation and flexibility, such as a polyimide film, a synthetic resin film, or a foam.

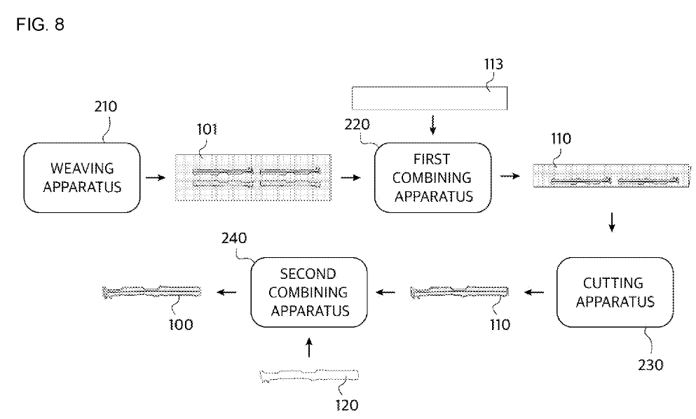

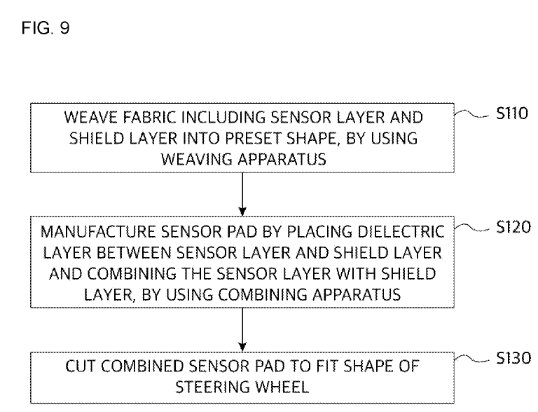

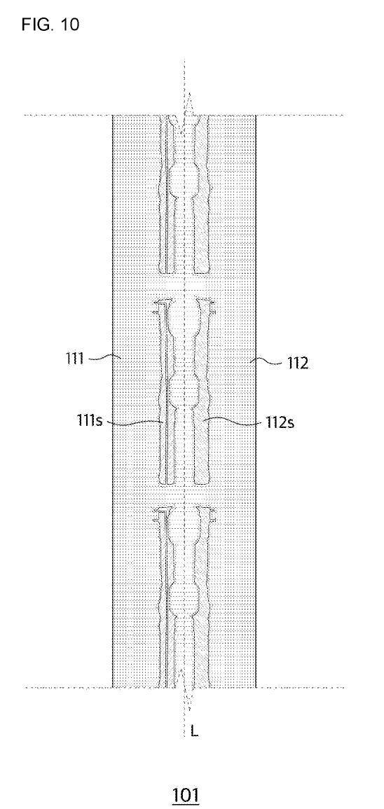

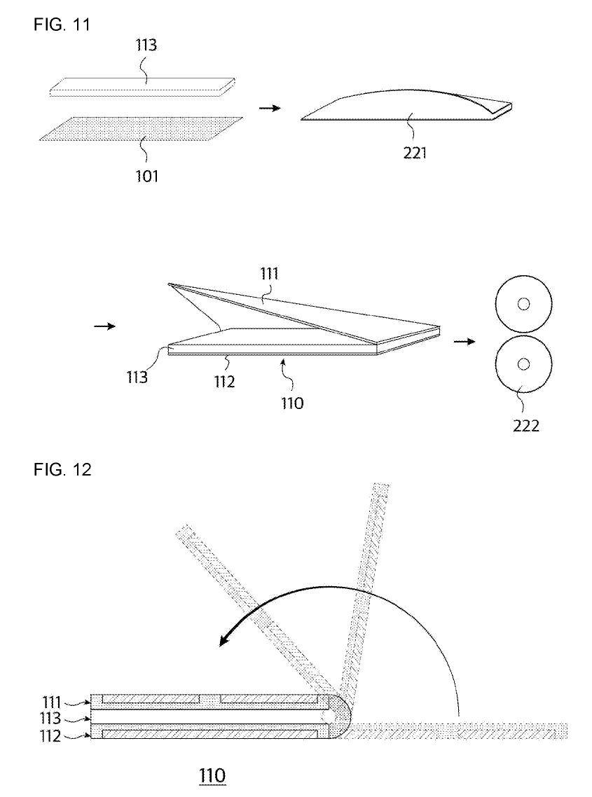

FIG. 8 is a conceptual diagram illustrating a method of manufacturing a steering wheel grip detection sensor according to an embodiment of the disclosure. FIG. 9 is a flowchart of the method of manufacturing the steering wheel grip detection sensor according to an embodiment of the disclosure; FIG. 10 is a diagram illustrating a fabric according to an embodiment of the disclosure. FIG. 11 is a conceptual diagram illustrating a process of combining a sensor pad according to an embodiment of the disclosure. FIG. 12 is a diagram illustrating the sensor pad according to an embodiment of the disclosure.

Referring to FIGS. 8-12, the method of manufacturing the steering wheel grip detection sensor according to the embodiment of the disclosure may include step S110 of weaving a fabric 101 including the sensor layer 111 and the shield layer 112 into a preset shape, by using a weaving apparatus 210, step S120 of manufacturing a sensor pad 110 by placing the dielectric layer 113 between the sensor layer 111 and the shield layer 112 and combining the sensor layer 111 with the shield layer 112, by using a first combining apparatus 220, and step S130 of cutting the combined sensor pad 110 to fit the shape of the steering wheel 10.

As shown in FIG. 8, in the weaving step S110, the fabric 101 may be weaved by using the weaving apparatus 210. The fabric 101 may be woven to include the sensor layer 111 and the shield layer 112, as shown in FIG. 10. The sensor layer 111 may be woven on one side of the fabric 101 with respect to a center line L (see FIG. 10) in a longitudinal direction, and the shield layer 112 may be woven on the other side. The sensor layer 111 and the shield layer 112 that are woven, may be symmetrical to each other with respect to the center line L in the longitudinal direction. In other words, in the weaving step S110, the sensor layer 111 and the shield layer 112 may be simultaneously woven through the weaving apparatus 210, but when the fabric 101 is folded with respect to the center line L in the longitudinal direction, the sensor unit 111s and the shield unit 112s may be woven to correspond to each other.

When the fabric 101 is prepared, step S120 of manufacturing the sensor pad 110 may be performed. In step S120 of manufacturing the sensor pad 110, as shown in FIG. 11, the sensor pad 110 may be manufactured by placing the dielectric layer 113 between the sensor layer 111 and the shield layer 112 and combining the sensor layer 111 and the shield layer 112, by using the first combining apparatus 220. In this regard, the dielectric layer 113 may be disposed between the sensor layer 111 and the shield layer 112 while folding the center line L of the fabric 101 such that the sensor layer 111 and the shield layer 112 face each other.

Specifically, as shown in FIG. 11, the fabric 101 may be inserted onto a conveyor or a roller in which a pad guide 221 is installed. The pad guide 221 serves as a guide such that the periphery of the center line L may be folded at a certain angle, and a central portion of the fabric 101 is gradually folded while passing through the pad guide 221. The shape of the pad guide 221 is designed such that an angle folded from an input unit to an output unit gradually changes, and thus, the fabric 101 does not bend rapidly at once and moves while naturally folding. In this process, the sensor layer 111 and the shield layer 112 inside the fabric 101 contact each other step by step along the center line L, and a separate insertion unit or supply apparatus may be linked such that the dielectric layer 113 may be inserted into a folding portion. The dielectric layer 113 is disposed between the sensor layer 111 and the shield layer 112 inside the fabric 101 folded in half, and then a pressing roller 222 combines the respective layers to closely adhere to each other by applying a certain pressure while allowing the fabric 101 folded in half and the dielectric layer 113 disposed between the sensor layer 111 and the shield layer 112 to pass therethrough, and thus, the sensor pad 110 may be manufactured.

When the sensor pad 110 is manufactured, step S130 of cutting the sensor pad 110 to fit the shape of the steering wheel 10 may be performed. Here, cutting the sensor pad 110 to fit the shape of the steering wheel 10 may mean cutting the sensor pad 110 to fit the shape in which an outer surface of the rim 11 is deployed so as to be attached to the rim 11 of the steering wheel 10. A cutting apparatus 230 such as a laser or a press may be used for cutting the sensor pad 110, but is not limited thereto. The sensor pad 110 may be cut such that the guard units 111g and 112g are formed around the sensor unit 111s or the shield unit 112s.

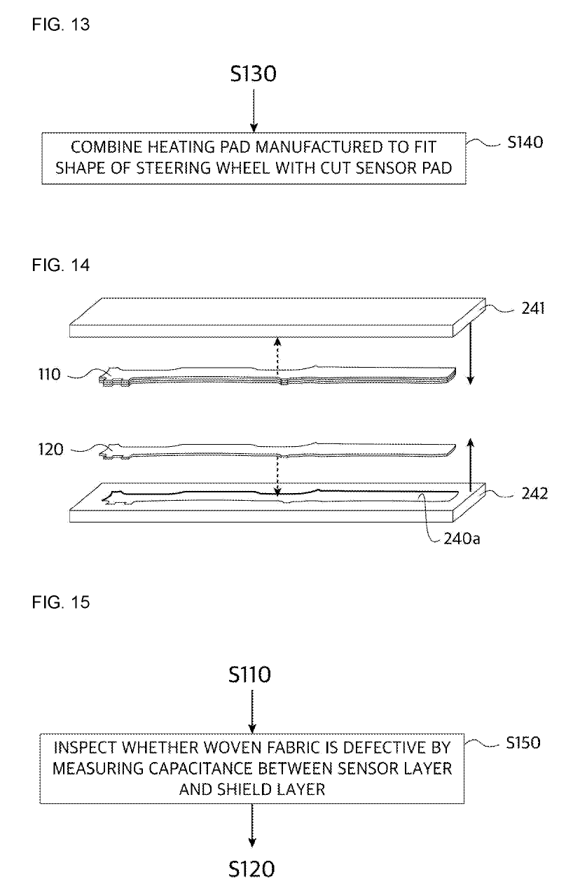

FIG. 13 is a flowchart of a method of manufacturing a steering wheel grip detection sensor according to an embodiment of the disclosure. FIG. 14 is a diagram illustrating combining a sensor pad with a heating pad by using jigs.

Referring to FIGS. 13 and 14, in an embodiment of the disclosure, the method of manufacturing the steering wheel grip detection sensor may further include step S140 of combining a heating pad 120 manufactured to fit the shape of the steering wheel 10 with the cut sensor pad 110. The heating pad 120 may be previously prepared to have the same shape as the sensor pad 110 that is cut to fit the rim 11 of the steering wheel 10. In step S140 of combining the heating pad 120, the sensor pad 110 and the heating pad 120 may be combined with each other using a second combining apparatus 240. In this regard, a method of compressing the sensor pad 110 and the heating pad 120 by using the jig may be used.

Specifically, a first jig 241 for fixing the sensor pad 110 and a second jig 242 for fixing the heating pad 120 are prepared. The first jig 241 and the second jig 242 may respectively have the same frames 240a as the shapes of the cut sensor pad 110 and the heating pad 120 for accurate position alignment. An adsorption means may be provided on the frame 240a of each of the first jig 241 and the second jig 242 such that the sensor pad 110 and the heating pad 120 may be fixed without misalignment. Using this, the sensor pad 110 is placed on the first jig 241, aligned, and then sucked and fixed, and the heating pad 120 is placed on the second jig 242, aligned, and then sucked and fixed. Thereafter, a predetermined pressure may be applied to the first jig 241 and the second jig 242 that face each other, and the sensor pad 110 and the heating pad 120 may be combined with each other by applying heat thereto or using an adhesive sheet or an adhesive.

When the sensor pad 110 and the heating pad 120 are completed, as shown in FIG. 1, the steering wheel grip detection sensor 100 may be completed by connecting a wire 102 to the sensor unit 111s and the shield unit 112s, and the completed steering wheel grip detection sensor 100 may be mounted on the steering wheel 10 by being attached to the outer surface of the rim 11 of the steering wheel 10.

FIG. 15 is a flowchart of a method of manufacturing a steering wheel grip detection sensor according to an embodiment of the disclosure.

Referring to FIGS. 10 and 15, in an embodiment of the disclosure, the method of manufacturing the steering wheel grip detection sensor may further include, after the weaving step S110, step S150 of inspecting whether the fabric 101 that has been woven is defective by measuring a capacitance between the sensor layer 111 and the shield layer 112 of the fabric 101 . For example, a defect of the fabric 101 may be detected by touching the sensor unit 111s with a hand by using electrical test equipment and measuring a change in the capacitance between the sensing unit 111s and the shield unit 112s. In addition, the defect may be detected by measuring surface resistance of the sensor unit 111s or shield unit 112s that is woven.

The electrodes (sensing unit and shield unit) in a stretchable fabric type may be formed in the steering wheel grip detection sensor of the disclosure, and thus, the steering wheel grip detection sensor may be smoothly adhered to the complex curved surface of the steering wheel having the circular rim, thereby improving grip detection accuracy.

In addition, the conductive yarn is woven in a wavy shape, and thus, the risk of disconnection and damage of the electrodes (sensing unit and shield unit) may be reduced, thereby preventing a short circuit phenomenon between the electrodes.

The steering wheel grip detection sensor according to an embodiment of the disclosure, the method of manufacturing the same, and the grip detection steering wheel may be naturally mounted on the curved shape of the steering wheel and accurately detect the driver's grip state.

The effects of the disclosure are not limited to the above-mentioned effects, and other effects not mentioned will be clearly understood by one of ordinary skill in the art from the description provided above.

Although the disclosure has been described with reference to the embodiment shown in the drawings, this is merely exemplary and will be understood by one of ordinary skill in the art that various modifications and equivalent other embodiments are possible. Therefore, the true technical protection scope of the disclosure will be defined by the technical sprit of the appended claims.

What is claimed is:

1. A capacitive steering wheel grip sensor comprising:
a stretchable fabric type sensor layer;
a stretchable fabric type shield layer; and
a dielectric layer disposed between the sensor layer and the shield layer,
wherein the sensor layer comprises a sensing unit woven with a conductive yarn and a guard unit woven with a non-conductive yarn to detect a driver's grip of a steering wheel.

2. The steering wheel grip sensor of claim 1, wherein the sensor layer is divided into a front detection region to detect a front side of the steering wheel and a rear detection region to detect a rear side of the steering wheel, and is woven with a non-conductive yarn between the front detection region and the rear detection region.

3. The steering wheel grip sensor of claim 2, wherein the shield layer has a shape corresponding to the sensor layer and includes a shield unit woven with a conductive yarn.

4. The steering wheel grip sensor of claim 1, wherein the conductive yarn is woven in a winding pattern in the sensing unit.

5. The steering wheel grip sensor of claim 1, wherein the sensing unit and the guard unit have a same surface height.

6. A method of manufacturing a steering wheel grip detection sensor, the method comprising:
weaving a fabric comprising a sensor layer and a shield layer into a preset shape, by using a weaving apparatus;
manufacturing a sensor pad by placing a dielectric layer between the sensor layer and the shield layer and combining the sensor layer with the shield layer, by using a combining apparatus; and
cutting the combined sensor pad to fit a shape of a steering wheel.

7. The method of claim 6, wherein
with respect to a center line in a longitudinal direction, the sensor layer is woven on one side of the fabric, and the shield layer is woven on the other side so as to be symmetrical to the sensor layer, and
the manufacturing of the sensor pad includes folding the fabric with respect to the center line such that the sensor layer and the shield layer overlap each other at a corresponding position.

8. The method of claim 6, further comprising: combining a heating pad manufactured to fit the shape of the steering wheel with the cut sensor pad,
wherein the combining of the heating pad includes sucking the sensor pad on a first jig, sucking the heating pad on a second jig, and compressing the sensor pad and the heating pad by pressing the first jig and the second jig to each other.

9. The method of claim 6, further comprising inspecting whether there is a defect by measuring a capacitance between the sensor layer and the shield layer.

10. A grip detection steering wheel comprising:
a rim of a steering wheel; and
a grip detection sensor surrounding the rim and detecting whether a driver grips the rim,
wherein the grip detection sensor comprises
a stretchable fabric type sensor layer;
a stretchable fabric type shield layer;
a dielectric layer disposed between the sensor layer and the shield layer, and
the sensor layer comprises a sensing unit woven with a conductive yarn and a guard unit woven with a non-conductive yarn to detect a driver's grip.

11. The grip detection steering wheel of claim 10, wherein the sensor layer is divided into a front detection region to detect a front side of the steering wheel and a rear detection region to detect a rear side of the steering wheel, and is woven with a non-conductive yarn between the front detection region and the rear detection region.
